(19) United States
(12) Patent Application Publication
(10) Pub. No.: US 2007/0067161 A1
(43) Pub. Date: Mar. 22, 2007

(54) Electronic talking pet collar

(75) Inventors: George T. Foster, Long Beach, CA (US); Elliot Rudell, Torrance, CA (US)

Correspondence Address: IRELL & MANELLA LLP, 840 NEWPORT CENTER DRIVE, SUITE 400, NEWPORT BEACH, CA, 92660, US

(73) Assignee: Elliot Rudell, Torrance, CA (US)

(21) Appl. No.: 11/232,481

(22) Filed: Sep. 21, 2005

(51) Int. Cl. G10L 11/00

(52) U.S. Cl. 704/200

(57) ABSTRACT

A pet collar with a voice recognition unit. The voice recognition unit can process words spoken by a user, and then generate audible words or phrases that are emitted from a speaker of the collar. By way of example, a user may say “FETCH” and the dog collar may generate a phrase “FETCH IT YOURSELF” or some other humorous phrase.

### BACKGROUND OF THE INVENTION

1. Field of the Invention

The present invention relates to a collar for a pet.

2. Prior Art

Voice recognition technology has been implemented into a number of different systems and commercial products. For example, there are computers that respond to voice commands, security systems that respond to voice commands and even voice mail that respond to voice commands. There have also been developed various toys and novelty items that responses to voice commands. By way of example, Takara Ltd. of Japan has marketed a product under the name BOW-LINGUAL. This product contains voice or sound recognition technology that responds to pet noises and then displays an interpretation of such noises on an LCD display located in a separate unit held by the user. BOW-LINGUAL is not activated by voice commands of the pet owner, and the response action of BOW-LINGUAL is a digital display of a word phrase on a handheld unit.

### BRIEF SUMMARY OF THE INVENTION

A pet collar that contains a voice processing unit. The voice processing unit generates an audible sound through a speaker of the pet collar in response to a spoken input received through a microphone of the collar.

### BRIEF DESCRIPTION OF THE DRAWINGS

FIG. 1 is an illustration of a pet collar on a pet;

FIG. 2 is an illustration of the pet collar;

FIG. 3 is a schematic of an electronic system of the pet collar.

### DETAILED DESCRIPTION

Disclosed is a pet collar with a voice recognition unit. The voice recognition unit can process words spoken by a user and generate audible words or phrases that are emitted from a speaker of the collar. By way of example, a user may say “FETCH” and the dog collar may generate a phrase “FETCH IT YOURSELF” or some other humorous phrase.

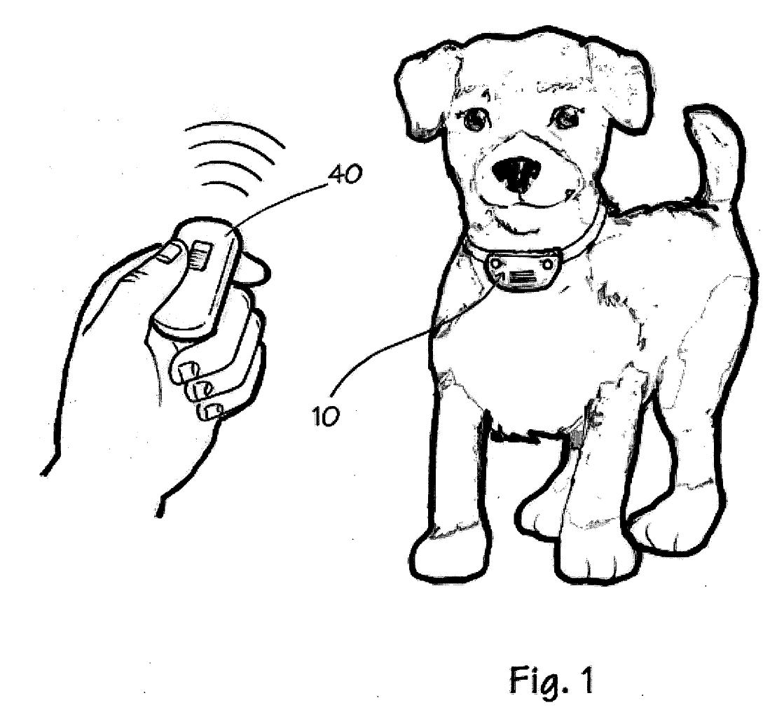

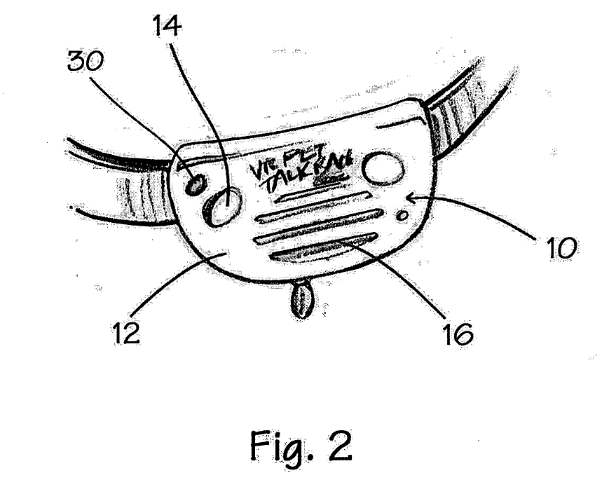

Referring to the drawings more particularly by reference numbers, FIGS. 1 and 2 show a pet collar 10 on a pet. The collar 10 includes a housing 12 that supports a microphone(s) 14 and a speaker 16. The housing 12 contains one or more various electronic circuits (not shown) that can process spoken words and phrases from a user(s) and generate responsive words or phrases. The responsive words or phrases may be of a humorous nature. Additionally, the responsive words or phrases may be in different languages or have different accents. For example, if the pet is a German Shepherd then the responsive words or phrases may have a German accent. Likewise, a French poodle may generate responsive words or phrases in a French accent.

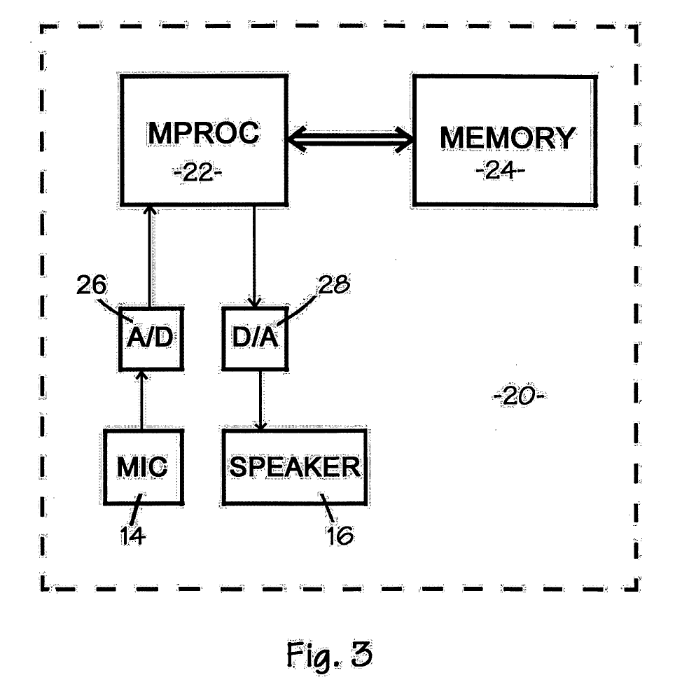

FIG. 3 is a schematic of an embodiment of an electronic system 20 of the pet collar 10. The system 20 may include a processor 22 and one or more memory devices 24. The processor 22 may be coupled to the microphone(s) 14 and speaker 16 by A/D 26 and D/A circuits 28, respectively. Alternatively, the processor 22 may have on-board A/D and D/A circuits. The processor 22 may also have on-board memory.

The processor 22 may operate in accordance with instructions and data of a computer program. The program may be software and/or firmware stored in memory 24. The computer program may include voice recognition software that can recognize spoken input received through the microphone(s) 14. Such software is provided by various sources including but not limited to Voice Signal of Massachusetts and Sensory Computing, Inc. of Santa Clara, Calif.

The computer program may process the spoken input, correlate the input to a word or phrase stored in memory 24 and then generate the correlated word or phrase through the speaker 16. For example, the user may say “SIT”. The processor 22 may process and correlate SIT with a responsive phrase such as “IF I SIT DOWN, I AM NOT GETTING BACK UP”. The computer program may correlate the input with a number of possible responsive words or phrases, or interchange that response with one of several others. The process may sequentially provide the responsive words or phrases in order, or out of order. For example, the first time the user says SIT, the collar may emit the phrase “IF I SIT DOWN, I AM NOT GETTING BACK UP”. The second time the user says SIT the collar may emit the phrase “SIT YOURSELF”. The responsive words and phrases may be stored in a look-up table. The table may have different accents and languages for each word or phrase.

The words and phrases recognized by the processing unit may be pre-programmed by the manufacturer, or entered by the user. Likewise, the responsive words and phrases may be entered by the user or pre-programmed by the manufacturer of the collar. The collar 10 may have an input button 30 (see FIG. 1) that can be depressed and used to enter words and phrases into memory.

The collar 10 may include an ON button that allows the user to activate the processor so that the system “listens” for a command word for a designated period of time. After that time period expires, the collar can automatically turn off to extend battery life during non-use. Alternatively, the collar 10 may contain an RF or infrared receiving circuit, allowing the device to be turned on and off by a small handheld transmitter 40 (shown in FIG. 1) carried by the pet owner. In this embodiment, the pet owner could send a signal to the collar to activate the electronic circuit, speak aloud a recognized command phrase, enjoy the auditory response from the speech chip on the device, and then send another remote signal to turn the device off.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A pet collar, comprising:
a housing;
a speaker coupled to said housing;
a microphone coupled to said housing; and,
a voice processing unit that processes a spoken input received through said microphone and generates an audible sound through said speaker.

2. The pet collar of claim 1, wherein said voice processing unit includes a processor that operates a computer program.

3. The pet collar of claim 2, wherein said spoken input is at least one word that is entered into said voice processing unit by a user.

4. The pet collar of claim 2, wherein said audible sound is generated from a table.

5. The pet collar of claim 4, wherein said table has different accents for said audible sound.

6. The pet collar of claim 4, wherein said table has different languages for said audible sound.

7. The pet collar of claim 1, further comprising a hand held transmitter that is coupled to a receiver coupled to said housing.

8. A pet collar, comprising:
a housing;
a speaker coupled to said housing;
a microphone coupled to said housing; and,
voice processing means for processing a spoken input received through said microphone and generating an audible sound through said speaker.

9. The pet collar of claim 8, wherein said voice processing means includes a processor that operates a computer program.

10. The pet collar of claim 9, wherein said spoken input is at least one word that is entered into said voice processing unit by a user.

11. The pet collar of claim 9, wherein said audible sound is generated from a table.

12. The pet collar of claim 11, wherein said table has different accents for said audible sound.

13. The pet collar of claim 11, wherein said table has different languages for said audible sound.

14. The pet collar of claim 8, further comprising a hand held transmitter that is coupled to a receiver coupled to said housing.

15. A method for operating a pet collar, comprising:
receiving a spoken input through a microphone of a pet collar; and,
generating an audible sound through a speaker of the pet collar in response to the spoken input.

16. The method of claim 15, wherein the spoken input is at least one word.

17. The method of claim 15, wherein the audible sound is generated from a table.

18. The method of claim 17, wherein the table has different accents for the audible sound.

19. The method of claim 17, wherein the table has different languages for the audible sound.

20. The method of claim 15, further comprising activating the pet collar with a hand held transmitter.
